(19) United States
(12) Patent Application Publication
(10) Pub. No.: US 2012/0064982 A1
(43) Pub. Date: Mar. 15, 2012

(54) METHOD AND EQUIPMENT FOR MAKING ADJUSTMENT SHAFTS

(75) Inventors: Roland Kolb, Hemhofen (DE); Wilhelm Putz, Erlangen (DE)

(73) Assignee: GEMO G. MORITZ GMBH & CO. KG, Krefeld (DE)

(21) Appl. No.: 13/209,064

(22) Filed: Aug. 12, 2011

Related U.S. Application Data
(63) Continuation of application No. 12/766,569, filed on Apr. 23, 2010, now abandoned.
Application No. 12/766,569 is a continuation of application No. 10/596,293, filed on Jul. 7, 2006, now abandoned.

(30) Foreign Application Priority Data
Dec. 12, 2003 (DE) 10358785.3
Dec. 12, 2003 (DE) 20319428.4

(51) Int. Cl. F16C 1/02; B23B 3/00

(52) U.S. Cl. 464/51; 82/1.11; 82/117

(57) ABSTRACT

Adjusting shafts including a noise-insulating outer sleeve and shaft ends that are free therefrom are produced in a brushing device by moving rotating brushes to an inserted shaft bar which is provided in an uninterrupted manner with the outer sleeve and removing the outer sleeve in the area of the shaft ends in a brushing-off process. Advantageously, one respective continuous section of the shaft ends of two adjusting shafts located one behind another is brushed off, whereupon the two shaft ends are separated from each other.

### CROSS-REFERENCE TO RELATED APPLICATIONS

This application is a continuation of U.S. application Ser. No. 12/766,569, which was filed on Apr. 23, 2010 and is currently pending, which application is a continuation of U.S. application Ser. No. 10/596,293, which was filed on Jul. 7, 2006 and is abandoned, which application was a U.S. national stage filing of PCT/EP2004/053320, which was filed on Dec. 7, 2004 and claims priority to DE 10358785.3, which was filed on Dec. 12, 2003, and DE 20319428, which was filed on Dec. 12, 2003.

### BACKGROUND OF THE INVENTION

The present invention relates to a method and to equipment for making adjustment shafts.

Adjustment shafts of the above kind are used in the form of a flexibly emplaceable adjustment means, in particular to transmit torques between a position transmitter that can be connected to one of the free shaft ends and a position receiver which can be connected to the other free shaft end; emplacement takes place for instance in cavities of motor vehicle parts. To abate noise between the moving adjustment shafts on one hand and the surrounding housing parts on the other hand, in particular automobile sheetmetal parts, the actual metallic shafts are strands and are enclosed by an acoustically damping external cladding, in particular textile flocks.

Such flock-coated adjustment shafts, having free ends, are manufactured from lengths of shaft strands, fitted continuously with an external cladding, by severing strand segments corresponding to the axial length desired of a specific adjustment shaft and by ridding the shaft ends needed for torque connection from the external cladding and shaping of said shaft ends, if required.

### BRIEF SUMMARY OF THE INVENTION

The objective of the present invention is an easily handled simple manufacture of adjustment shafts which are acoustically damped between their free metallic ends by external cladding.

The method and the equipment of the present invention permit simple and reliable manufacture—which can be automated—and employ a continuous metal shaft strand fitted with an external cladding. They make it possible to brush clean each zone of the shaft end which must be kept rid from said external cladding in purposeful manner, assuring quality of work. Appropriately, the zone to be kept cladding-free runs over two adjoining shaft ends of two consecutive shafts-to-be that shall be severed from one another only after their junction has been brushed clean and that, if necessary, are fitted with a geometrically interlocking torque coupling shape.

Short working times with compact designs are attained in particular with two radially opposite brushes that act as rotating brushes on the shaft length to be brushed clean and in that the brushes are tangentially pivotable about the metal strand for the purpose of a progressive elimination of the external cladding on it. This procedure is implemented by an advantageous design whereby the rotating brushes are received in a support concentric with the strand and rotatable about it, in particular in a brush head.

The invention and further implementing/embodying modes of the dependent claims are elucidated below by means of illustrative examples and in relation to the appended drawings.

### BRIEF DESCRIPTION OF THE DRAWINGS

FIG. 1 is an axial section in elevation of equipment of the invention to manufacture adjustment shafts of which the ends have been rid of the external cladding,

FIG. 2 is a section II-II of the equipment of FIG. 1,

FIG. 3 is an adjustment shaft of which the external cladding has been removed at both shaft ends,

FIG. 4 is a continuous strand comprising two zones where the external cladding has been removed and also shows brushes moved toward one of these zones,

FIG. 5 is an enlarged view of an end-face topview on the left end face of the adjustment shaft of FIG. 3, and

FIG. 6 is an enlarged end-face view of the left end-face section of the strand along line VI-VI of FIG. 4.

### DETAILED DESCRIPTION OF THE INVENTION

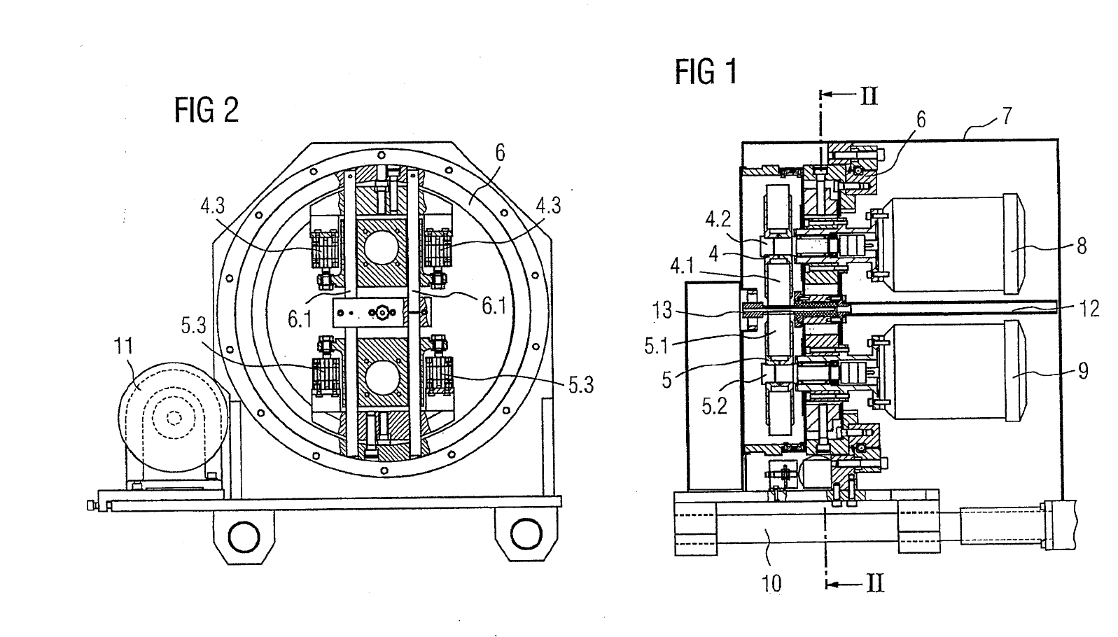

The equipment of the invention shown in FIGS. 1 and 2 comprises a first, right-hand axial guide 12 comprising position affixing means and, an axial free space away, a second, left-hand axial guide 13 also fitted with position fixing means for a shaft strand 3 (not shown here) of FIG. 4 that can be fixed in a brushing position.

Two rotating and mutually faced braced brushes 4 and 5 are configured in the clear space between the right-hand and left-hand position fixing means and can be moved radially toward the peripheral surfaces of the shaft strand. The brushes 4 and 5 are driven by the drive elements 4.2, 5.2 of electric motors 8, 9, said drive elements being configured radially parallel to the longitudinal axis predetermined by the guides 12, 13.

In one embodiment of the present invention, the brushes 4, 5 are respectively radially displaceable along radial guide rails 6.1, 6.1 by drive units 4.3, 5.3. In a further embodiment of the present invention, the brushes 4, 5 may be moved radially toward the shaft strand, for the purpose of removing the external cladding, a distance such that the tips of the bristles 4.1, 5.1 of the brushes 4, 5 barely reach the peripheral surface of the free shaft ends during operation, that is at maximum rotational speed.

Appropriately, only a support in the form of an oppositely located support roller is used when there is only a single rotating brush.

The total brushing apparatus inclusive the brush drive unit and brush adjustment means is received in a pivotably supported brush head 6 configured concentrically with the axial guides 12, 13 and hence with the shaft strand in a fixed housing 7. In one design of the present invention, the brush head 6 is pivotably supported relative to the housing 7 so as to be driven externally from a drive unit 11 whereby, using only a minimum of flexible power and control lines, the entire external surface of the shaft strand can be rid of the external cladding in the region of the shaft ends to be bared.

In a further implementation of the present invention attaining high flexibility regarding different flocks by means of the external cladding or different lengths of the bare shaft ends, the brush head 6 is made axially displaceable and its seating is provided along axial guide rails 10 in relation to the shaft strand to be received by the guide 12.

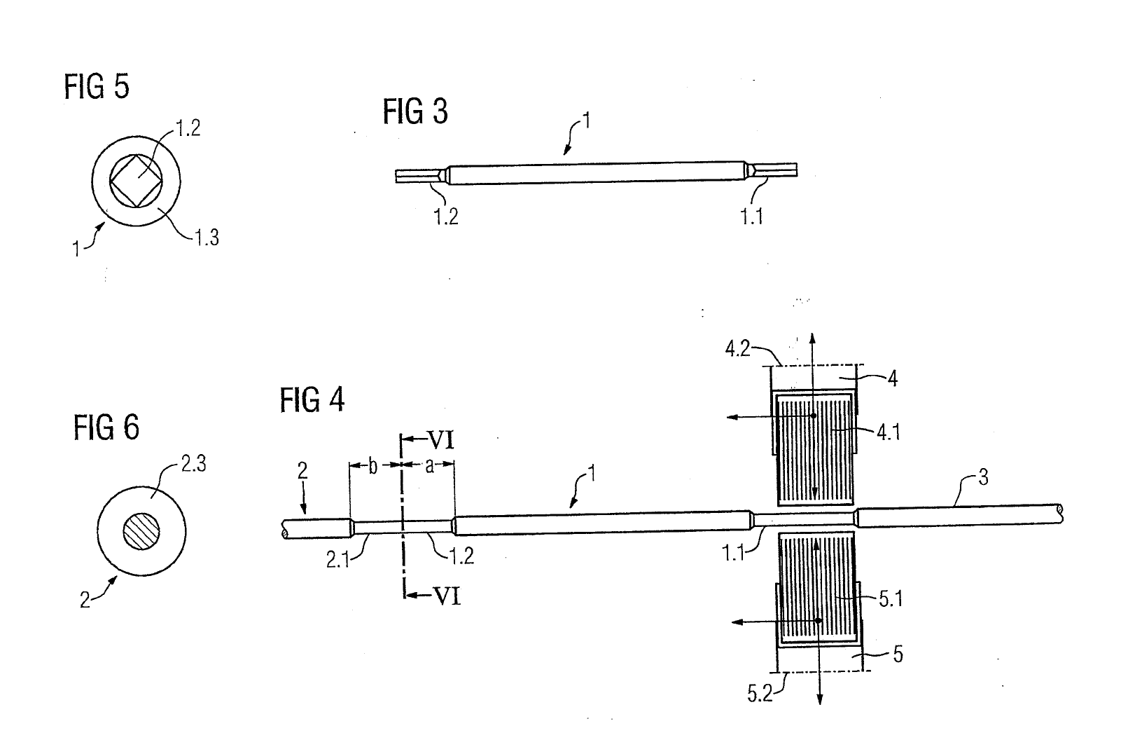

FIG. 3 is a side view and FIG. 5 is a front view of a finished adjustment shaft 1 fitted with an external cladding 1.3 between the free shaft ends 1.1 and 1.2 from which said cladding has been abraded by the brushes. The finished shaft 1 was made from a shaft strand 3 that was unwound from a supply roll, for instance, and that was continuously covered with an external cladding. This abrasion procedure is also shown schematically in FIGS. 4 and 6.

Rotating brushes 4, 5 are moved toward a fairly long shaft strand 3 continuously fitted with an external cladding in a manner that the tips of the brush bristles 4.1, 5.1 abrade the cladding down to the peripheral surface of the inner, stranded metallic shaft. Advantageously, the brushes 4, 5 are pivotable in a concentric and arcuate manner relative to the shaft strand so that the brushes 4, 5 can process the peripheral surface from all around them.

In a further design of the present invention, the brush head 6 and hence the brushes 4, 5 are displaceable in such manner in the direction of the shaft strand that, regardless of brush width, arbitrary lengths of bared shaft ends can be made, for instance by merely shifting in a timed manner the operational range of the brush system.

The left part of FIG. 4 shows a finished brush zone a, b advantageously consisting of two consecutive shaft ends 1.2, 2.1 of an adjustment shaft 1 and a consecutive adjustment shaft 2. The brush zone has a length zone a for the shaft end 1.2 of the adjustment shaft 1 and a length zone b for the shaft end 2.1 of the adjustment shaft 2. By dividing the originally continuous brush zone a, b at the transition zone, the adjustment shaft 2 is separated from the shaft strength 3 and thereby from the adjustment shaft 1.

The essential concept of the present invention may be summarized as follows:

To manufacture adjustment shafts 1, 2 fitted with a noise-abating external cladding 1.3, 2.3 and shaft ends 1.1, 1.2, 2.1 bared from such cladding, rotating brushes 4, 5 are moved within a brush unit toward an inserted shaft strand 3 which is continuously fitted with said cladding that is then removed from the shaft end zones by being abraded by said brushes. Appropriately in each such procedure, one continuous zone a, b of the shaft ends of two consecutive and adjoining adjustment shafts is abraded clean by the said brushes, whereupon the two shaft ends are severed from one another.

What is claimed is:

1. A method for manufacturing adjustment shafts comprising a metallic shaft and a noise-abating, non-metallic external cladding situated between cladding-free shaft ends, comprising the steps of:
starting with a metallic shaft strand continuously fitted with said external cladding, said cladding is removed in the zone of the axially continuous shaft ends of two consecutive adjustment shafts by at least one radially approachable brush which is pivoted tangentially about at least a portion of the circumference of the metallic shaft strand in the sense of a progressive peripheral removal of the external cladding from said strand, and
subsequently severing the shaft strand in a transition region of the shaft ends.

2. The method as claimed in claim 1, wherein the brush is approached in a manner that the radial length of its bristles operationally extends maximally as far as the peripheral surface of the bared shaft ends.

3. The method as claimed in claim 1, wherein the shaft strand is fitted in the region of the bared shaft-ends with a geometrically interlocking torque transmitting connector of which an outer contour deviates from the circular form and in particular is square.

4. Equipment with which to manufacture adjustment shafts comprising a metallic shaft and a noise-abating non-metallic external cladding wherein between the shaft ends the shaft is bared of said cladding, at least one rotary brush being provided which can be applied radially to a metallic shaft strand continuously fitted with the external cladding and which can be pivoted about said strand.

5. The equipment as claimed in claim 4, wherein at least two rotating brushes are preferably configured at the periphery of the shaft strand in a mutually opposite manner and are radially approachable.

6. The equipment as claimed in claim 5, wherein the rotating brushes are received in a support, in particular a brush head configured to be rotatable about and concentric with the shaft strand.

7. The equipment as claimed in claim 6, wherein shafts of the rotating brushes are each parallel to and radially offset from an axis of the brush head and are affixed in the brush head.

8. The equipment as claimed in claim 6, wherein the brush head is axially displaceable relative to the shaft strand.

9. The equipment of claim 6, wherein the equipment comprises a plurality of brush heads, each driven by a dedicated motor.

10. An adjustment shaft comprising a metallic shaft and a noise-abating, non-metallic external cladding situated between cladding-free shaft ends, made by the process of: starting with a metallic shaft strand continuously fitted with said external cladding, removing said cladding the zone of the shaft ends by at least one externally applicable brush.
